(19) United States
(12) Patent Application Publication
(10) Pub. No.: US 2026/0176416 A1
(43) Pub. Date: Jun. 25, 2026

(54) MANUFACTURING METHOD OF POLYESTER

(71) Applicant: NAN YA PLASTICS CORPORATION, Taipei City (TW)

(72) Inventors: Ching-Yao Yuan, Taipei City (TW); Cheng-Shui Huang, Taipei City (TW); Chung Yu Chen, Taipei City (TW); Zhang-Jian Huang, Taipei City (TW); Mong-Chen Chang, Taipei City (TW)

(73) Assignee: NAN YA PLASTICS CORPORATION, Taipei City (TW)

(21) Appl. No.: 19/068,015

(22) Filed: Mar. 3, 2025

(30) Foreign Application Priority Data
Dec. 23, 2024 (TW) 113150159

(51) Int. Cl. C08G 63/183; C08J 11/24

(52) U.S. Cl. CPC C08G 63/183; C08J 11/24; C08J 2367/03

(57) ABSTRACT

A manufacturing method of polyester includes: a first recycled material, a second recycled material, ethylene glycol and a phosphorus-containing monomer are provided, in which the first recycled material includes polyethylene terephthalate (PET), and the second recycled material includes bis-2-hydroxylethyl terephthalate (BHET), polyethylene terephthalate dimer, polyethylene terephthalate trimer, mono(2-hydroxyethyl) terephthalic acid or combinations thereof; the first recycled material, the second recycled material, the ethylene glycol and the phosphorus-containing monomer are used to perform a depolymerization and monomer bonding step to obtain a polyethylene terephthalate containing phosphorus monomer oligomer; a catalyst is provided; and the polyethylene terephthalate containing phosphorus monomer oligomer and the catalyst are used to perform a copolymerization step.

### CROSS-REFERENCE TO RELATED APPLICATION

This application claims the priority benefit of Taiwan application serial no. 113150159, filed on Dec. 23, 2024. The entirety of the above-mentioned patent application is hereby incorporated by reference herein and made a part of this specification.

### BACKGROUND

### Technical Field

The disclosure relates to a manufacturing method of flame-resistant polyester.

### Description of Related Art

In products such as 3C transmission cables, fabrics spun and woven from materials such as flame-resistant polyester are commonly used. However, products manufactured through current manufacturing methods of polyester may possess numerous issues, thereby reducing product competitiveness thereof. Therefore, how to improve the manufacturing method of polyester is indeed a challenge.

### SUMMARY

The disclosure provides a manufacturing method of polyester, which may possess good product competitiveness.

A manufacturing method of polyester of the disclosure includes: a first recycled material, a second recycled material, ethylene glycol and a phosphorus-containing monomer are provided, in which the first recycled material includes polyethylene terephthalate, and the second recycled material includes bis-2-hydroxylethyl terephthalate, polyethylene terephthalate dimer, polyethylene terephthalate trimer, mono(2-hydroxyethyl) terephthalic acid or combinations thereof; the first recycled material, the second recycled material, the ethylene glycol and the phosphorus-containing monomer are used to perform a depolymerization and monomer bonding step to obtain a polyethylene terephthalate containing phosphorus monomer oligomer; a catalyst is provided; and the polyethylene terephthalate containing phosphorus monomer oligomer is used to perform a copolymerization step.

In an embodiment of the disclosure, the phosphorus-containing monomer may be any one of

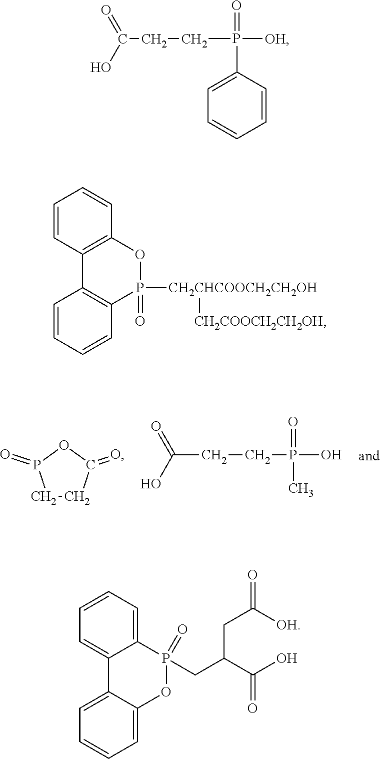

In an embodiment of the disclosure, an operating temperature of the depolymerization and monomer bonding step may be between 190° C. and 230° C., and an operating temperature of the copolymerization step may be between 230° C. and 280° C.

In an embodiment of the disclosure, operating time of the depolymerization and monomer bonding step may be between 1 hour and 4 hours, and operating time of the copolymerization step may be between 1 hour and 5 hours.

In an embodiment of the disclosure, operating pressure of the copolymerization step may be between 0.2 torr and 2 torr.

In an embodiment of the disclosure, a use weight ratio of the second recycled material to the first recycled material may be between 0.05 and 0.34.

In an embodiment of the disclosure, a use weight ratio of the ethylene glycol to the first recycled material may be between 0.20 and 0.40.

In an embodiment of the disclosure, a ratio of a phosphorus weight of the phosphorus-containing monomer to a total weight of the first recycled material, the second recycled material, and the phosphorus-containing monomer may be greater than 0.0065.

In an embodiment of the disclosure, the catalyst may include organometals, ionic liquids or combinations thereof.

In an embodiment of the disclosure, the organometals may include organic zinc (e.g., zinc acetate), organic cobalt (e.g., cobalt acetate), organic titanium (e.g., alkyl titanium salts), organic antimony (e.g., antimony acetate and antimony ethylene glycol), organic aluminum (e.g., aluminum formate, aluminum acetate, aluminum propionate, and other aluminum organic acids), chelated titanium catalysts, or other suitable catalysts, in which the catalyst may be used individually or in combination with multiple types, and the ionic liquids may include imidazolium-based ionic liquids (e.g., 1-butyl-3-methylimidazolium chloride and 1-ethyl-3-methylimidazolium acetate).

Based on the above, the disclosure, through the design of steps such as depolymerizing various recycled materials and bonding the depolymerized recycled materials with the phosphorus-containing monomer to form the polyethylene terephthalate containing phosphorus monomer oligomer, followed by copolymerization with the catalyst, may simultaneously improve issues that arise from current physical mixing and chemical modification methods, such as poor processability, poor flame resistance, long thermal history and carbon footprint, color difference, and lack of environmental friendliness. As a result, high-quality flame-resistant polyester may be produced, possessing good product competitiveness.

In order to make the aforementioned features and advantages of the disclosure comprehensible, embodiments accompanied with drawings are described in detail as follows.

### BRIEF DESCRIPTION OF THE DRAWINGS

The FIGURE is a partial flow diagram of a manufacturing method of polyester according to an embodiment of the disclosure.

### DESCRIPTION OF THE EMBODIMENTS

In the following detailed description, for purposes of description rather than limitation, an exemplary embodiment disclosing specific details is set forth to provide a thorough understanding of various principles of the disclosure. However, it will be apparent to people of ordinary skill in the art that the disclosure may be practiced in other embodiments departing from the specific details disclosed herein, benefiting from the disclosure. Moreover, descriptions of known devices, methods, and materials may be omitted to avoid obscuring the description of the various principles of the disclosure.

The disclosure is more fully described with reference to the drawings of the embodiment. However, the disclosure may be embodied in various forms and should not be limited to the embodiment described herein.

Unless otherwise defined, all terms (including technical and scientific terms) used herein have the same meaning as commonly understood by people of ordinary skill in the field to which the disclosure pertains.

The term “between” used in this specification for defining numerical ranges is intended to cover ranges equal to the stated endpoint values as well as ranges between the stated endpoint values. For example, a dimensional range between a first value and a second value may cover the first value, the second value, and any value between the first value and the second value.

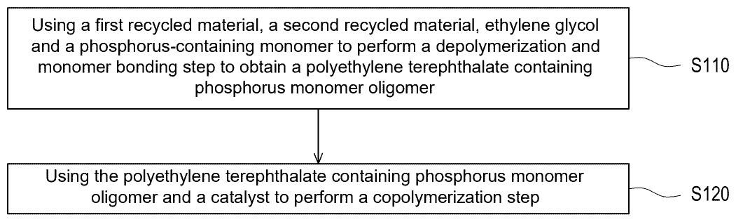

The FIG. 1s a partial flow diagram of a manufacturing method of polyester according to an embodiment of the disclosure. Referring to the FIGURE, the manufacturing method of polyester of the embodiment at least includes the following steps.

First, a first recycled material, a second recycled material, ethylene glycol and a phosphorus-containing monomer are provided, in which the first recycled material includes polyethylene terephthalate (PET), the second recycled material includes bis-2-hydroxylethyl terephthalate (BHET), polyethylene terephthalate dimer, polyethylene terephthalate trimer, mono(2-hydroxyethyl) terephthalic acid or combinations thereof or other suitable polyethylene terephthalate oligomers, preferably bis-2-hydroxylethyl terephthalate. Then, as shown in step S110, the aforementioned first recycled material, second recycled material, ethylene glycol and phosphorus-containing monomer are used to perform a depolymerization and monomer bonding step to obtain a polyethylene terephthalate containing phosphorus monomer oligomer. Here, the definition of oligomer is a PET polymer with a degree of polymerization of approximately 3 to 5.

Next, as shown in step S120, the polyethylene terephthalate containing phosphorus monomer oligomer and a catalyst are used to perform a copolymerization step, in which intrinsic viscosity (IV) of the flame-resistant polyester formed in the step may be greater than 0.52 (dl/g), a color value L may be greater than 75%, a may be between ±3, b may be between ±6, and the average filament breakage rate of the subsequent product may be less than or equal to 4 times/day, the spinning yield may be greater than or equal to 80%, and the flame resistance may be M1 grade. Accordingly, the embodiment, through the design of steps such as depolymerizing various recycled materials and bonding the depolymerized recycled materials with the phosphorus-containing monomer to form the polyethylene terephthalate containing phosphorus monomer oligomer, followed by copolymerization with the catalyst, may simultaneously improve issues that arise from current physical mixing and chemical modification methods, such as poor processability, poor flame resistance, long thermal history and carbon footprint, color difference, and lack of environmental friendliness. As a result, high-quality flame-resistant polyester may be produced, possessing good product competitiveness.

Furthermore, the flame-resistant polyester formed by the current physical mixing method is formed by co-extrusion, cooling, and pelletizing using an extruder, therefore the flame-resistant polyester is prone to filament breakage in the subsequent spinning process, resulting in poor processability issues. At the same time, due to poor mixing uniformity, the flame-resistant polyester also has issues such as poor flame resistance. On the other hand, the current chemical modification method uses phthalic acid (PTA), ethylene glycol and a phosphorus-containing monomer to directly conduct esterification copolymerization reaction to form flame-resistant polyester, and the process often requires long-term high temperature, thus resulting in issues such as long thermal history and poor color. Moreover, due to the long carbon footprint and the ease of producing waste during the manufacturing process, the current chemical modification method also does not meet environmental protection requirements. Based on this, since the manufacturing method of the embodiment does not adopt the physical mechanism of extrusion molding, nor does the manufacturing method adopt the chemical mechanism of raw materials such as phthalic acid, the copolymer structure formed by the manufacturing method of the embodiment may improve the issues produced in the current mechanisms, but the disclosure is not limited thereto.

The following will sequentially exemplify probable operational details of the above-mentioned steps. However, the descriptions are not intended to limit the disclosure.

### <Depolymerization and Phosphorus-Containing Monomer Bonding Step>

In some embodiments, when conducted under more favorable operating conditions, enhanced improvement effects may be obtained. For example, the operating temperature of the depolymerization and phosphorus-containing monomer bonding step may be between 190° C. and 230° C. and/or the operating time of the depolymerization and phosphorus-containing monomer bonding step may be between 1 hour and 4 hours. More favorable operating conditions may be an operating temperature between 200° C. and 220° C. and/or an operating time between 1 hour and 3 hours, but the disclosure is not limited thereto.

In some embodiments, in the depolymerization and phosphorus-containing monomer bonding step, the use weight ratio of the second recycled material to the first recycled material may be between 0.05 and 0.34, preferably between 0.1 and 0.2, but the disclosure is not limited thereto. Here, the use weight ratio of the second recycled material to the first recycled material is the use weight of the second recycled material divided by the use weight of the first recycled material, that is, the use weight of the second recycled material is less than the use weight of the first recycled material.

In some embodiments, the use weight ratio of ethylene glycol to the first recycled material may be between 0.20 and 0.40, but the disclosure is not limited thereto. Here, the use weight ratio of ethylene glycol to the first recycled material is the use weight of ethylene glycol divided by the use weight of the first recycled material, that is, the use weight of ethylene glycol is less than the use weight of the first recycled material.

In some embodiments, the source of the first recycled material may be recycled films, recycled PET bottles, recycled fibers or similar materials. The recycling method for the second recycled material may be, for example, waste PET polyester subjected to suitable ethylene glycol decomposition and purification processes. However, the disclosure is not limited thereto. The first recycled material and the second recycled material may be manufactured using any suitable sources and recycling methods known to people of ordinary skill in the art.

In some embodiments, a color phase L of the first recycled material may be greater than 58%, a may be between ±1, b may be between ±1, while a color phase L of the second recycled material may be greater than 90%, a may be between ±1, b may be between ±1, but the disclosure is not limited thereto.

In some embodiments, the ratio of the phosphorus weight of the phosphorus-containing monomer to the total weight of the first recycled material, the second recycled material, and the phosphorus-containing monomer may be greater than 0.0065, but the disclosure is not limited thereto. Here, the ratio of the phosphorus weight of the phosphorus-containing monomer to the total weight of the first recycled material, the second recycled material, and the phosphorus-containing monomer is the phosphorus weight of the phosphorus-containing monomer divided by the total weight of the first recycled material, the second recycled material, and the phosphorus-containing monomer.

In some embodiments, the phosphorus-containing monomer may be any one of

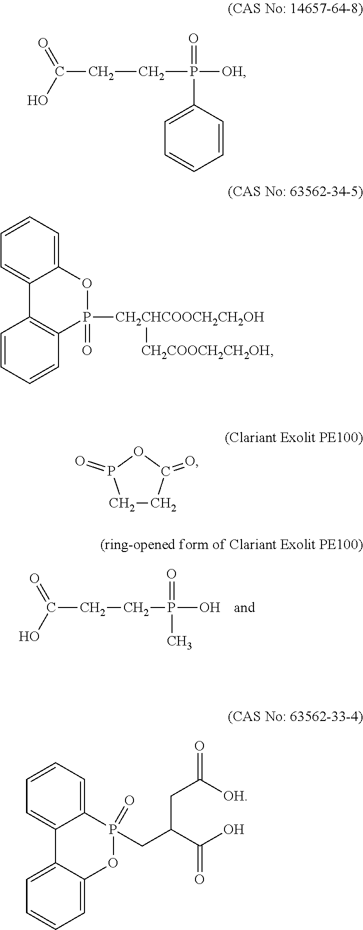

to possess enhanced reactivity, but the disclosure is not limited thereto.

### <Copolymerization Step>

In some embodiments, the operation may be conducted under more favorable conditions to obtain enhanced improvement effects. For example, the operating temperature of the copolymerization step may be between 230° C. and 280° C. and/or the operating time of the polymerization step may be between 1 hour and 5 hours. More favorable operating conditions may be that the operating temperature of the polymerization step may be between 240° C. and 270° C. and/or the operating time of the polymerization step may be between 2 hours and 4 hours, but the disclosure is not limited thereto.

In some embodiments, the copolymerization pressure may also be controlled to be between 0.2 torr and 2 torr, preferably between 0.5 torr and 1.5 torr, but the disclosure is not limited thereto.

In some embodiments, the catalyst may include organometals, ionic liquids, or combinations thereof. For example, the organometals may include organic zinc (e.g., zinc acetate), organic cobalt (e.g., cobalt acetate), organic titanium (e.g., alkyl titanium salts), organic antimony (e.g., antimony acetate and antimony ethylene glycol), organic aluminum (e.g., aluminum formate, aluminum acetate, aluminum propionate, and other aluminum organic acids), chelated titanium catalysts, or other suitable catalysts. The catalyst may be used individually or in combination with multiple types. The ionic liquids may include imidazolium-based ionic liquids (e.g., 1-butyl-3-methylimidazolium chloride and 1-ethyl-3-methylimidazolium acetate), but the disclosure is not limited thereto. Here, the catalyst may also further include titanium dioxide.

The following examples and comparative examples are given to illustrate the effects of the disclosure, but the scope of claims of the disclosure is not limited to the scope of the examples.

The polyester produced in each of the examples and comparative examples is evaluated according to the following method.
Intrinsic viscosity (IV): ASTM D4603 test method.
Phosphorus content: After pretreatment of the ester pellet samples, the absorbance is quantified using a UV-Vis spectrometer.
Color: The color space defined by the International Commission on Illumination (CIE Lab) is adopted. The Lab color space is a color-opponent space with dimension L representing lightness (called the whiteness of the color), and a and b representing the color-opponent dimensions, based on nonlinearly compressed CIE XYZ color space coordinates.
Yield: Actual amount of qualified polyester obtained/Amount of input first recycled material (PET) raw material*100%.
Average filament breakage rate: Total number of filament breakages/Production time (days)
Flame resistance: NF P 92-507 standard is adopted.

The polyester of Example 1 may be manufactured in the following manner.

Corresponding to step S110, 60 kg of first recycled material (recycled PET bottle material), 20 kg of second recycled material (bis-2-hydroxylethyl terephthalate), 20 kg of ethylene glycol, 3 kg of phosphorus-containing monomer (compound 1, CAS NO.: 14657-64-8) are used to perform a depolymerization and monomer bonding step to obtain a bis-2-hydroxylethyl terephthalate oligomer. Furthermore, under the operating conditions of a reaction tank heating temperature of 265° C., pressure of 0.8 bar and time of 2 hours, the temperature of the above materials is raised from room temperature to 225° C./230° C. and maintained at the temperature for 0.5 hours. The above reactants perform the depolymerization and monomer bonding step in the reaction tank.

Corresponding to step S120, the obtained bis-2-hydroxylethyl terephthalate oligomer and the catalyst (antimony ethylene glycol (antimony addition amount: 275 ppm), 0.5 kg of titanium dioxide) are used to perform the copolymerization step to obtain the flame-resistant polyester of Example 1. Furthermore, under the operating conditions of a reaction tank heating temperature of 275° C. and a reaction pressure decreasing from atmospheric pressure to 20 torr in 1 hour, a pre-polymerization reaction is conducted for 60 minutes. Then, under the operating conditions of a reaction temperature of 265° C. and a reaction pressure of <1.0 torr for 120 minutes, the main polymerization reaction is conducted to perform the copolymerization step.

### Polyester of Example 2 and Comparative Example 1

The manufacturing method is the same as the manufacturing method of the above Example 1, with the merely difference being the use weights of the first recycled material, second recycled material, and ethylene glycol, in which the use weights may be referred to in Table 1.

TABLE 1

| | | Example | Example | Comparative |
|---|---|---|---|---|
| | | 1 | 2 | Example 1 |
| First recycled material | Weight | 60 | 67.5 | 75 |
| Second recycled material | (kg) | 20 | 10 | 0 |
| Ethylene glycol | | 20 | 22.5 | 25 |
| Depolymerization | ° C. | 225 | 230 | 235 |
| temperature | | | | |
| Flame-resistant monomer | Type | Compound 1 CAS NO.: 14657-64-8 | | |
| | Weight | 3 | 3 | 3 |
| | (kg) | | | |

The characteristics and spinning evaluation of the polyester of Examples 1 to 2 and Comparative Example 1 are shown in Table 2.

TABLE 2

| | | | | Comparative |
|---|---|---|---|---|
| | | Example 1 | Example 2 | Example 1 |
| Characteristics of | Intrinsic viscosity (dl/g) | 0.629 | 0.631 | 0.624 |
| flame-resistant | Phosphorus content (ppm) | 6,550 | 6,612 | 6,545 |
| polyester | L | 81.2 | 79.5 | 78.0 |
| | a | −2.2 | −3.3 | −2.3 |
| | b | 4.9 | 5.6 | 6.3 |
| Spinning evaluation | Yield (%) | 90 | 80 | 70 |
| | Average filament breakage rate | 2 | 4 | 7 |
| | (times/day) | | | |
| | Flame resistance | M1 | M1 | M1 |

In summary, the disclosure, through the design of steps such as depolymerizing various recycled materials and bonding the depolymerized recycled materials with the phosphorus-containing monomer to form the bis-2-hydroxylethyl terephthalate oligomer, followed by copolymerization with the catalyst, may simultaneously improve issues that arise from current physical mixing and chemical modification methods, such as poor processability, poor flame resistance, long thermal history and carbon footprint, color difference, and lack of environmental friendliness. As a result, high-quality flame-resistant polyester may be produced, possessing good product competitiveness.

Although the disclosure has been described with reference to the above embodiments, the described embodiments are not intended to limit the disclosure. People of ordinary skill in the art may make some changes and modifications without departing from the spirit and the scope of the disclosure. Thus, the scope of the disclosure shall be subject to those defined by the attached claims.

What is claimed is:

1. A manufacturing method of polyester, comprising:
providing a first recycled material, a second recycled material, ethylene glycol and a phosphorus-containing monomer, wherein the first recycled material comprises polyethylene terephthalate, and the second recycled material comprises bis-2-hydroxylethyl terephthalate, polyethylene terephthalate dimer, polyethylene terephthalate trimer, mono(2-hydroxyethyl) terephthalic acid or combinations thereof;
using the first recycled material, the second recycled material, the ethylene glycol and the phosphorus-containing monomer to perform a depolymerization and monomer bonding step to obtain a polyethylene terephthalate containing phosphorus monomer oligomer;
providing a catalyst; and
using the polyethylene terephthalate containing phosphorus monomer oligomer and the catalyst to perform a copolymerization step.

2. The manufacturing method of polyester according to claim 1, wherein the phosphorus-containing monomer is any one of

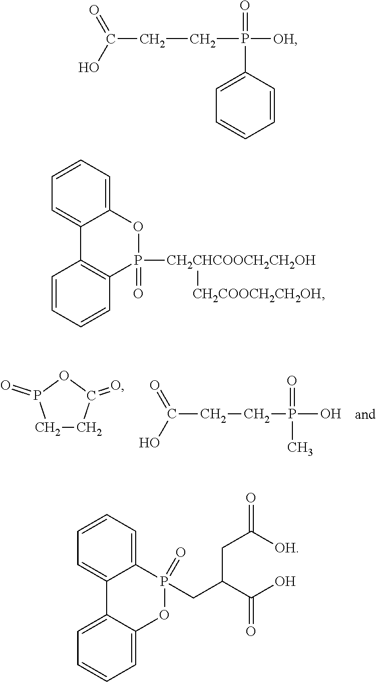

3. The manufacturing method of polyester according to claim 1, wherein an operating temperature of the depolymerization and monomer bonding step is between 190° C. and 230° C., and an operating temperature of the copolymerization step is between 230° C. and 280° C.

4. The manufacturing method of polyester according to claim 1, wherein operating time of the depolymerization and monomer bonding step is between 1 hour and 4 hours, and operating time of the copolymerization step is between 1 hour and 5 hours.

5. The manufacturing method of polyester according to claim 1, wherein operating pressure of the copolymerization step is between 0.2 torr and 2 torr.

6. The manufacturing method of polyester according to claim 1, wherein a use weight ratio of the second recycled material to the first recycled material is between 0.05 and 0.34.

7. The manufacturing method of polyester according to claim 1, wherein a use weight ratio of the ethylene glycol to the first recycled material is between 0.20 and 0.40.

8. The manufacturing method of polyester according to claim 1, wherein a ratio of a phosphorus weight of the phosphorus-containing monomer to a total weight of the first recycled material, the second recycled material and the phosphorus-containing monomer is greater than 0.0065.

9. The manufacturing method of polyester according to claim 1, wherein the catalyst comprises organometals, ionic liquids or combinations thereof.

10. The manufacturing method of polyester according to claim 9, wherein the organometals comprise zinc acetate, organic titanium, organic antimony, organic aluminum or combinations thereof, and the ionic liquids comprise imidazolium ionic liquids.
